(19) United States
(12) Patent Application Publication
(10) Pub. No.: US 2026/0109842 A1
(43) Pub. Date: Apr. 23, 2026

(54) RECYCLING A MULTILAYER SYSTEM

(71) Applicant: Bostik SA, COLOMBES (FR)

(72) Inventors: Christophe ROBERT, VENETTE (FR); Romain PUCHOIS, VENETTE (FR)

(21) Appl. No.: 19/118,031

(22) PCT Filed: Oct. 5, 2023
(86) PCT No.: PCT/FR2023/051547

§ 371 Date: Apr. 3, 2025

(30) Foreign Application Priority Data
Oct. 12, 2022 (FR) FR2210475

(51) Int. Cl. C08L 23/12; B29B 17/02; B29B 17/04; B29K 23/00; B29K 105/26; C08J 5/12

(52) U.S. Cl. CPC C08L 23/12; C08J 5/128; B29B 17/02; B29B 17/0412; B29K 2023/12; B29K 2105/26; B29K 2995/0089; C08J 2323/12; C08J 2353/02; C08L 2205/02; C08L 2205/035; C08L 2207/20

(57) ABSTRACT

The present invention relates to a multilayer system F1 comprising: a layer C1 comprising at least one polypropylene, an adhesive layer Ad consisting of a hot-melt pressure-sensitive adhesive composition PC, and a layer C2 comprising at least one polypropylene, said multilayer system F1 comprising at least 80% by weight of polypropylene or of a mixture of polypropylenes, with respect to the total weight of said system. The invention also relates to 10 the use of said system F1 in order to prepare a recycled article.

### FIELD OF THE INVENTION

The present invention relates to a process for the recycling of a multilayer system.

The present invention also relates to the use of a hot-melt pressure-sensitive adhesive composition or of a multilayer system for preparing a recycled article.

### TECHNOLOGICAL BACKGROUND

Multilayer articles (or laminated articles) are used in many fields for the packaging of a wide variety of products, in particular in the food processing, cosmetics and detergents sectors. Depending on the requirements, these articles can be flexible or rigid. They are in particular flexible packagings. These articles generally consist of different materials (multilayer composite articles). The materials can be chosen from paper, metal or thermoplastic polymers. The thermoplastic polymers can be chosen from polyethylene (PE), polypropylene (PP), copolymers of ethylene and of vinyl acetate (EVA), polyamide (PA), polyethylene terephthalate (PET), polyvinyl chloride (PVC), polyvinylidene fluoride (PVDF), polymers resulting from lactic acid (PLA), a polyhydroxyalkanoate (PHA) or their mixtures.

An individual layer of material can itself consist of several materials. It can, for example, be a layer of thermoplastic polymers obtained by coextrusion of two polymers (there is then no adhesive between the coextruded layers); the individual layers of thermoplastic polymer can additionally be coated with a substance (for example based on aluminum oxide or on silicon oxide), with a layer of protein or a metallized layer (metallization with aluminum particles) to add an additional barrier effect.

The characteristics and properties of multilayer articles will depend in particular on the materials used to produce the layers. Thus, it is common practice to combine layers comprising different materials in order to obtain multilayer articles, very generally composite multilayer articles, combining the characteristics and the properties of the different individual layers and thus having particular characteristics and properties, for example in terms of visual appearance, of gas- and moisture-barrier properties, of harmlessness or of absence of toxicity to users, of inertness with respect to packaged products, of chemical resistance to packaged products and/or of physical, mechanical, thermal and chemical resistance to manufacturing and packaging processes.

The layers can be assembled by lamination using lamination processes or by coextrusion. These lamination processes can be carried out by use of adhesive compositions or of suitable devices.

Multilayer articles include resealable trays, which are used in the food-processing industry and mass marketing to package foodstuffs, in particular fresh products. Such packagings are described by the patent U.S. Pat. No. 4,673,601 and the patent application EP 1 053 952. These trays are based on hot-melt pressure-sensitive adhesive compositions typically comprising tackifying resins and styrenic block copolymers. The hot-melt adhesive compositions are also commonly referred to as HMPSA compositions, corresponding to the initials of the term “Hot-Melt Pressure-Sensitive Adhesive”. These are substances which are solid at ambient temperature and which contain neither water nor solvent. Applied in the molten state, they solidify as they cool, thus forming an adhesive layer which provides the bonding between the two thin layers of thermoplastic polymeric material to be assembled, while providing the corresponding packaging with the advantageous opening and reclosing properties.

There exists today a great diversity of multilayer articles comprising characteristics and properties suitable for multiple uses. However, these articles generally have the disadvantage of being single-use articles and of generating waste. In order to meet the challenge of climate change, to reduce environmental pollution, to save on natural resources and to adapt to more stringent regulations, it is imperative to develop recycling and upgrading channels for this waste.

Despite the development of various recycling and upgrading channels, many multilayer articles are difficult to recycle, whether for reasons of yield, of technical feasibility, of performance, of cost, and the like. Thus, for example, the recycled materials obtained do not necessarily have the characteristics and the properties required for the production of new articles, such as molded articles: deterioration of the mechanical and/or physical properties, incompatibility, haze, and the like.

There thus exists a need for new solutions which make it possible to overcome these disadvantages, at least in part.

There thus exists a real need to provide multilayer articles which can be recycled, in particular in a mechanical manner, to result in recycled articles having satisfactory mechanical and physicochemical properties and characteristics.

### DESCRIPTION OF THE INVENTION

### Use of a Multilayer System F1

The present invention relates to the use of a multilayer system F1 comprising:
a layer C1 comprising at least one polypropylene,
an adhesive layer Ad consisting of a hot-melt pressure-sensitive adhesive composition PC comprising:
   a composition (a1) of styrenic block copolymers comprising at least one elastomer block;
   one or more tackifying resins (a2);
a layer C2 comprising at least one polypropylene,
   said multilayer system F1 comprising at least 80% by weight of a polypropylene or of a mixture of polypropylenes, with respect to the total weight of said system, in order to prepare a recycled article.

### Multilayer System F1

The multilayer system F1 necessarily comprises at least these three layers C1, C2 and Ad.

In the context of the present invention, the terms “article”, “structure” and “system” are used equivalently.

The multilayer system F1 can be a laminate, a complex or a film.

Advantageously, the multilayer system F1 is mechanically recyclable.

The term “mechanically recyclable” is used to indicate that the multilayer system F1 can be converted into a new article via a mechanical recycling process.

Mechanical recycling has been known for many years. In environmental terms, mechanical recycling (in comparison with chemical recycling) is the most energy-efficient and generates little waste. Chemical recycling is in particular defined by the standard ISO-15270 as being the conversion into monomers or the production of new starting substances by modification of the chemical structure of plastic waste by cracking, gasification or depolymerization, with the exception of energy recovery and of incineration.

In the context of the invention, the term “mechanical recycling” is understood to mean the definition given in the standard ISO-15270, namely the treatment of plastic waste to give products or secondary starting substance, without significant modification of the chemical structure of the substance, for example without modification of the chemical functions and of the repeat units. Mechanical recycling comprises at least one mechanical stage of grinding.

In the context of the invention, the terms “recycled” and “recyclate” refer to a material resulting, at least in part, either from post-consumer waste or from industrial waste. Post-consumer waste relates to objects which have been used by the consumer at least once (that is to say that they have served their original purpose), while industrial waste relates to manufacturing residues that do not reach the consumer. Manufacturing residues can, for example, be scraps from reels of multilayer complexes when they are cut after production to prepare packagings.

In the context of the invention, the term “virgin” refers to newly produced materials and/or articles prior to their first use and which have not been recycled.

### Layers C1 and C2

The layer C1 can comprise a polypropylene or a mixture of polypropylenes.

The layer C2 can comprise a polypropylene or a mixture of polypropylenes.

The layers C1 and C2 can comprise one or more polypropylenes having different physicochemical characteristics.

An example of polypropylene of the same chemical nature (same chemical composition) but with different physicochemical characteristics is: the layer C1 comprises a polypropylene having an MFI <10 g/10 min, the layer C2 comprises a polypropylene having an MFI >10 g/10 min. Thus, the chemical nature is identical, polypropylene, but the physicochemical characteristics, such as the MFI, are different.

The physicochemical characteristics of the layers C1 and C2 can be different, for example due to differences in the molecular weight of the polypropylene(s), the degree of branching of the polypropylene(s), the MFI, the density of the polypropylene(s), the thickness of the layer, and the like.

The layers C1 and C2 can comprise one or more identical or different polypropylenes.

The term “polypropylene” covers homopolymers and copolymers prepared from propylene, said copolymers comprising at least more than 50 mol % of units derived from propylene monomer(s).

The polypropylenes can be prepared by different methods, such as polymerization in the presence of a Ziegler-Natta catalyst or metallocene catalyst.

There also exist commercial polypropylenes, such as, for example, RC2472, available from HMC Polymers; RD226CF, available from Borealis; Eltex P, available from Ineos; PPR 3260, available from Total; RD204CF (random copolymer, MFI=8 g/10 min at 230° C./2.16 kg), available from Borealis.

The thickness of the layer C1 can vary from 10 to 120 μm, preferably from 10 to 100 μm.

The thickness of the layer C2 can vary from 10 to 120 μm, preferably from 10 to 100 μm.

Each of the layers C1 and C2, independently of each other, can comprise one or more additives, for example chosen from the group consisting of glidants, pigments, inks, fillers, heat stabilizers, UV stabilizers, antistatic agents and their mixtures.

Preferably, each of the layers C1 and C2, independently of each other, comprises more than 80% by weight of polypropylene, more preferentially more than 90% by weight and more preferentially still more than 99% by weight of a polypropylene (or of a mixture of polypropylenes), with respect to the total weight of said layer C1 (or C2, respectively).

The two abovementioned layers C1 and C2 are preferably bonded together by the adhesive layer Ad.

Each of the layers C1 and C2, independently of each other, can comprise at least one layer chosen from aluminum oxides (AlOₓ), silicon oxides (SiOₓ), a metallization layer and their mixtures.

The metallization layer is well known in the field, and corresponds to a very thin layer of aluminum, typically having a thickness of less than 100 nm, preferably ranging from 3 to 60 nm. The layer can be produced conventionally by vapor deposition on the surface of the substrate (of the layer C1 and/or C2).

The AlOₓ and SiOₓ layers are typically less than 500 nm, preferably less than 200 nm, for example of the order of 5 to 150 nm.

If they are present on the layers C1 and/or C2, these layers (AlOₓ, SiOₓ or metallization layer) can be in direct contact with the adhesive layer.

### Adhesive Layer Ad/Hot-Melt Adhesive Composition PC

The thickness of the adhesive layer Ad can be of between 1 and 50 μm, preferably of between 5 and 35 μm and more preferentially still of between 5 and 25 μm. The percentages by weight of the ingredients are with respect to the total weight of said hot-melt pressure-sensitive adhesive composition PC.

In the context of the present invention, the term “copolymer” refers to a polymer obtained by the polymerization of at least two different monomers. The term “copolymer” includes terpolymers which comprise three different types of monomers.

Unless otherwise indicated, the standards mentioned throughout the patent application are those in force at the date of filing of the patent application.

### Composition (a1) of Styrenic Block Copolymers Comprising at Least One Elastomer Block

The styrenic block copolymers employed in the composition (a1) have a weight-average molar mass Mw generally of between 50 kDa and 500 kDa.

These styrenic block copolymers consist of blocks of various polymerized monomers including at least one polystyrene block, and are prepared by radical polymerization techniques.

Unless otherwise indicated, the weight-average molar masses Mw which are given in the present text are expressed in daltons (Da) and are determined by gel permeation chromatography, the column being calibrated with polystyrene standards.

The triblock copolymers include two polystyrene blocks and one elastomer block. They can assume various structures: linear, star-branched (also denoted radial), branched or else comb-shaped. The diblock copolymers include one polystyrene block and one elastomer block.

The triblock copolymers have the general formula:

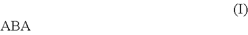

in which:
   A represents a non-elastomer styrenic (or polystyrene) block, and
   B represents an elastomer block which can be:
      polyisoprene. The block copolymer then has the structure: polystyrene-polyisoprene-polystyrene and has the name: SIS;
      polyisoprene, followed by a polybutadiene block. The block copolymer then has the structure: polystyrene-polyisoprene-polybutadiene-polystyrene and has the name: SIBS; -polybutadiene. The block copolymer then has the structure: polystyrene-polybutadiene-polystyrene and has the name: SBS;
      totally or partially hydrogenated polybutadiene. The block copolymer then has the structure: polystyrene-poly(ethylene-butylene)-polystyrene and has the name: SEBS;
      totally or partially hydrogenated polyisoprene. The block copolymer then has the structure: polystyrene-poly(ethylene-propylene)-polystyrene and has the name: SEPS.

In the above triblock copolymer, the blocks A on either side of B can be identical or different; for example, they can each have a different length.

The diblock copolymers have the general formula:

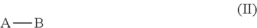

in which A and B are as defined above.

When the composition (a1) comprises several triblock styrenic copolymers, the latter being chosen from the group consisting of SIS, SBS, SEPS, SIBS and SEBS, it is clearly understood that said triblocks can belong to just one or to several of these five families of copolymers. It is the same, mutatis mutandis, for the diblock copolymers.

It is preferred to use a composition (a1) comprising a triblock copolymer and a diblock copolymer having the same elastomer block, due in particular to the fact that such mixtures are commercially available.

Preferably, the composition (a1) of styrenic block copolymers comprising at least one elastomer block consists, on the basis of its total weight:
of from 10% to 90% by weight of at least one diblock copolymer chosen from the group consisting of SI, SBI, SIB, SB, SEB and SEP, and
of from 10% to 90% by weight of at least one triblock copolymer chosen from the group consisting of SIS, SIBS, SBS, SEBS and SEPS.

Preferably, the content of composition (a1) in the hot-melt pressure-sensitive adhesive composition PC ranges from 30% to 80% by weight, preferably from 40% to 70% by weight, with respect to the total weight of said composition PC.

The total content of styrenic units of said composition (a1) preferably varies from 10% to 40% by weight, on the basis of the total weight of (a1).

According to a particularly preferred alternative embodiment, the content of diblock copolymer in the composition (a1) can vary from 15% to 80%, preferably from 50% to 80%.

Preferably, the composition (a1) consists of an SIS triblock copolymer and of an SI diblock copolymer. In this case, the total content of styrenic units of the composition (a1) preferably varies from 10% to 25%.

The triblock copolymers included in the composition (a1) preferably have a linear structure.

The styrenic block copolymers having an elastomer block, in particular of SI and SIS type, which can be used in the composition (a) are commercially available, often in the form of triblock/diblock mixtures.

Kraton® D1111 from Kraton and Quintac® 3520 and Quintac® 3433 N from Zeon Chemicals are examples of compositions (a1) consisting of SIS and SI.

Kraton® D1111 is a composition, the overall content of styrenic units of which is 22%, and which consists of 82% of linear SIS triblock copolymer with an Mw of approximately 250 kDa and of 18% of SI diblock copolymer with an Mw of approximately 100 kDa.

Quintac® 3520 is a composition which consists, respectively, of 22% and of 78% of linear SIS triblock (Mw approximately 300 kDa) and of SI diblock (Mw approximately 130 kDa), and the total content of styrenic units of which is 15%.

Quintac® 3433 N is a composition which consists, respectively, of 44% and of 56% of linear SIS triblock (Mw approximately 220 kDa) and of SI diblock (Mw approximately 110 kDa), and the total content of styrenic units of which is 16.5%.

### Tackifying Resins (a2)

The tackifying resin(s) (a2) which can be used have weight-average molar masses Mw generally of between 300 and 5000 Da and are chosen in particular from:
(i) rosins of natural origin or modified rosins, such as, for example, the rosin extracted from pine gum, the wood rosin extracted from tree roots and their derivatives resulting from hydrogenation, dehydrogenation, dimerization, polymerization or esterification with monoalcohols or polyols, such as glycerol;
(ii) resins obtained by hydrogenation, polymerization or copolymerization (with an aromatic hydrocarbon) of mixtures of unsaturated aliphatic hydrocarbons having approximately 5, 9 or 10 carbon atoms resulting from petroleum cuts;
(iii) terpene resins generally resulting from the polymerization of terpene hydrocarbons, such as, for example, monoterpene (or pinene), in the presence of Friedel-Crafts catalysts, which are optionally modified by the action of phenols;
(iv) copolymers based on natural terpenes, for example styrene/terpene, α-methylstyrene/terpene and vinyltoluene/terpene.

The softening temperature (or point) of the tackifying resins which can be used in the composition according to the invention can vary from 5° C. to 140° C. The softening temperature is determined in accordance with the standardized test ASTM E 28, the principle of which is as follows. A brass ring with a diameter of approximately 2 cm is filled with the resin to be tested in the molten state. After cooling to ambient temperature, the ring and the solid resin are placed horizontally in a thermostatically controlled bath of glycerol, the temperature of which can vary by 5° C. per minute. A steel ball with a diameter of approximately 9.5 mm is centered on the disk of solid resin. The softening temperature is the temperature, during the phase of rise in temperature of the bath at the rate of 5° C. per minute, at which the disk of resin yields by a height of 25.4 mm under the weight of the ball.

Preferably, the resin (a2) is chosen from aliphatic resins belonging to the categories (ii) or (iii). Mention may be made, as examples of commercially available resin, of:
(ii) Escorez® 1310 LC available from Exxon Chemicals, which is a resin obtained by polymerization of a mixture of unsaturated aliphatic hydrocarbons having approximately 5 carbon atoms, and which has a softening temperature of 94° C. and a weight-average molar mass Mw of approximately 1800 Da; Escorez® 5400 also available from Exxon Chemicals, which is a resin obtained by polymerization and then hydrogenation of a mixture of unsaturated aliphatic hydrocarbons having approximately 9 or 10 carbon atoms and which has a softening temperature of 100° C. and an Mw of approximately 570 Da; Regalite® R1125, available from Eastman, which is a hydrogenated resin which has a softening temperature of 123° C. and a weight-average molar mass Mw of approximately 1200 Da;
(iii) Dercolyte® S115 available from Dérivés Résiniques et Terpéniques (or DRT), which is a terpene resin having a softening temperature of 115° C. and an Mw of approximately 2300 Da.

### Hot-Melt Pressure-Sensitive Adhesive Composition PC

Preferably, the hot-melt pressure-sensitive adhesive composition PC comprises:
from 40% to 70% by weight of a composition (a1) of styrenic block copolymers comprising at least one elastomer block, said composition (a1) consisting, on the basis of its total weight:
   of from 10% to 90% by weight of at least one diblock copolymer chosen from the group consisting of SI, SBI, SIB, SB, SEB and SEP, and
   of from 10% to 90% by weight of at least one triblock copolymer chosen from the group consisting of SIS, SIBS, SBS, SEBS and SEPS;
   the total content of styrenic units of said composition (a1) varying from 10% to 40% by weight, on the basis of the total weight of (a1); and
from 30% to 60% by weight of one or more tackifying resins (a2).

More preferentially, the composition PC comprises or consists essentially of:
from 50% to 70% of the composition (a1) of styrenic block copolymers; and
from 30% to 50% of at least one tackifying resin (a2) having a softening temperature of between 5° C. and 140° C.

The hot-melt pressure-sensitive adhesive composition PC can also comprise, besides the composition (a1) and the tackifying resin(s) (a2), from 0.1% to 2% of one or more stabilizers (or antioxidants). These compounds are introduced in order to protect the composition from degradation resulting from a reaction with oxygen which is liable to be formed by the action of heat, light or residual catalysts on certain starting materials, such as the tackifying resins. These compounds can include primary antioxidants, which trap free radicals and are generally substituted phenols, such as Irganox® 1010 from BASF. The primary antioxidants can be used alone or in combination with other antioxidants, such as phosphites, for instance Irgafos® 168, also from BASF, or again with UV stabilizers, such as amines.

The composition PC can also comprise a plasticizer, but in an amount not exceeding 5%. Use may be made, as plasticizer, of a paraffinic and naphthenic oil (such as Primol® 352 from Esso) optionally comprising aromatic compounds (such as Nyflex 222B).

Finally, the composition PC can comprise inorganic or organic fillers, pigments or dyes.

### Multilayer System F1

The multilayer system F1 can moreover comprise one or more additional layers (in addition to the abovementioned layers C1, Ad and C2).

They can be barrier layers (for example, layer based on proteins, layer based on aluminum oxides (AlOₓ), on silicon oxides (SiOₓ), on aluminum, on PVOH (polyvinyl alcohol), on copolymers of ethylene and of vinyl alcohol (EVOH), on copolymers of ethylene and of alkyl acrylate, on copolymers of ethylene and of vinyl acetate (EVA), and the like), tie layers (also called intermediate layers), printable layers, receptacle layers, and the like.

The total thickness of the multilayer system F1 can be liable to vary within a wide range extending, for example, from 20 to 500 μm.

Preferably, the multilayer system F1 comprises at least 80% by weight, preferentially at least 85% by weight and more preferentially still at least 90% by weight of polypropylene or of a mixture of polypropylenes, with respect to the total weight of said system.

The multilayer system F1 can be obtained by any process known in the field.

The process can comprise a stage of coextrusion of the hot-melt pressure-sensitive adhesive composition PC and of the constituent materials of the layers C1 and C2 and, if appropriate, of additional layers.

The coextrusion device can be a bubble blowing coextrusion device (also known under the name of “blown film coextrusion device”). In a way known to a person skilled in the art, this process comprises:
the melting, in separate extruders, of the constituent materials and compositions of the layers Ad, C1 and C2, then
the passing of the corresponding streams through an assembly of annular and concentric dies, so as to form a tubular bubble comprising several layers, in the order corresponding to that desired for the final structure, then
the radial expansion (relative to the annular die) and the drawing (in the axial direction) of the bubble, then
the cooling of the bubble.

The geometrical characteristics of the dies, as well as the parameters of the process, such as the degree of radial expansion and the drawing rate, are set so as to obtain the thicknesses desired for the various constituent layers of the multilayer film. Reference is made in particular, for a fuller description of the bubble blowing coextrusion process, to the patent application US2013/0029553.

### Recycled Article

The recycled article can be a single-layer film, a laminate, a (multilayer) complex or a molded article, preferably a molded article.

The molded article can be a blow molded article or an injection molded article. The molded article is preferably an injection molded article. Injection molding is well known. It is typically a process in which a thermoformable material is melted and injected at high pressure into a mold to form an article of a given size and given shape.

In the context of the invention, the term “single-layer film” is understood to mean a film comprising a single layer, and thus differing from multilayer films.

The recycled article is preferably obtained by mechanical recycling of the multilayer system F1 according to the invention.

The recycled article preferably comprises less than 5% by weight of styrenic block copolymers, with respect to the total weight of said recycled article.

The content of styrenic block copolymers can be determined by gel permeation chromatography (GPC), with an appropriate standard.

The recycled article preferably comprises at least 90%, more preferentially at least 95%, more preferentially still at least 97%, by weight of polypropylene or of a mixture of polypropylenes, with respect to the total weight of said recycled article.

The recycled article preferably comprises at least 2% by weight of the multilayer system F1 as defined in the present patent application, preferably at least 5% by weight, with respect to the total weight of said recycled article.

The recycled article advantageously exhibits a breaking force of greater than or equal to 20 MPa, preferably of greater than or equal to 22 MPa, measured according to the standard ISO 527-1 (type 1A, test specimen dimensions 80×10×4 mm, pull rate 50 mm/min).

The recycled article advantageously exhibits an impact strength (Charpy method) of greater than or equal to 5.0, preferably of greater than or equal to 5.5, measured according to the standard ISO 179-2 1 eA at 23° C. (test specimens dimensions 80×10×4 mm, rate of 2.9 m/s).

The recycled article advantageously exhibits an elongation at break of greater than or equal to 7 MPa, preferably of greater than or equal to 8 MPa, measured according to the standard ISO 527-1 (type 1A, test specimens dimensions 80×10×4 mm, pull rate 50 mm/min).

The present invention also relates to the use of the hot-melt pressure-sensitive adhesive composition PC according to the invention in order to improve the impact strength of a recycled article, preferably a polypropylene-based recycled article.

More particularly, the use of the hot-melt pressure-sensitive adhesive composition PC of the invention advantageously makes it possible to improve by at least 2%, preferably by at least 5%, more preferentially still by at least 15%, the impact strength of a recycled article comprising said hot-melt pressure-sensitive adhesive composition, in comparison with a control article consisting of 100% polypropylene (preferably recycled polypropylene) and devoid of said hot-melt pressure-sensitive adhesive composition. It is obvious for the recycled article and the control article to have similar sizes and shapes for an appropriate comparison.

The impact strength is measured according to the abovementioned standard.

The recycled article is preferably prepared according to the process described below.

The present invention also relates to the use of the hot-melt pressure-sensitive adhesive composition PC according to the invention in order to improve the elongation at break of a recycled article, preferably of a polypropylene-based recycled article.

The elongation at break is measured according to the abovementioned standard.

More particularly, the use of the hot-melt pressure-sensitive adhesive composition PC of the invention advantageously makes it possible to enhance by at least 2%, preferably by at least 5% and more preferentially still by at least 15% the elongation at break of a recycled article comprising said hot-melt pressure-sensitive adhesive composition, in comparison with a control article consisting of 100% polypropylene (preferably recycled polypropylene) and devoid of said hot-melt pressure-sensitive adhesive composition. It is obvious for the recycled article and the control article to have similar sizes and shapes for an appropriate comparison.

The recycled article is preferably prepared according to the process described below.

### Uses of the Hot-Melt Pressure-Sensitive Adhesive Composition PC

The present invention also relates to the use of the hot-melt pressure-sensitive adhesive composition PC comprising:
a composition (a1) of styrenic block copolymers comprising at least one elastomer block;
one or more tackifying resins (a2);
   in order to prepare a recycled article.

The description, embodiments and modes which are preferred described above for the hot-melt pressure-sensitive adhesive composition PC apply for the use without it being necessary to repeat them.

The present invention relates to the use of the hot-melt pressure-sensitive adhesive composition PC as defined above in order to prepare a recycled article comprising at least 2% by weight of a recycled multilayer system F1 comprising said adhesive composition PC, preferably at least 5% by weight, with respect to the total weight of said recycled article.

### Process for the Preparation of a Recycled Article

The present invention also relates to a process for the preparation of a recycled article, said process comprising:
a) the provision of the multilayer system F1 as described in the present invention;
b) the conversion of the multilayer system F1 into flakes;
c) the optional mixing of the flakes obtained in stage b) with recycled or virgin polypropylene;
d) the conversion of the flakes from stage b) or of the mixture from stage c) into a recycled article.

The description, embodiments and modes which are preferred described above for the multilayer system F1 apply for the present process for the preparation of a recycled article, without it being necessary to repeat them.

Stage b) is preferably a grinding stage advantageously resulting in flakes. It can be carried out at 23° C.

The process can comprise an optional stage b-1) of washing the flakes obtained in stage b), and a drying stage b-3).

The washing stage b-1) can be carried out with water, optionally in the presence of additives, optionally with stirring.

The washing stage b-1) advantageously makes it possible to remove residues present in the packagings, such as, for example, food waste or cosmetic residues from cosmetic packagings, or also to remove inks possibly present, or others.

The washing stage b-1) can be carried out at a temperature ranging from 20° C. to 25° C.

The process can comprise a flotation stage b-2) between stage b-1) and stage b-3). This stage can be carried out by any means known to a person skilled in the art.

The flakes resulting from the washing stage iii-1) can be placed, during the washing stage or after the washing stage, in a tank with stirring. After stirring has halted, the flotation/separation stage advantageously makes it possible to separate the products which float from those (preferentially impurities) which are deposited at the bottom of the stirring tank. The flotation stage is typically a density separation stage. Polyolefins typically have a density of less than 1 g/cm³, which makes it possible to recover them generally at the surface.

The drying stage b-3) can be carried out by any known method. It can be carried out at a temperature ranging from 50° C. to 100° C.

In the context of the invention, and unless otherwise mentioned, the term “virgin polypropylene” is understood to mean a newly produced polypropylene, which has not been recycled.

The process can comprise a stage b′) of densification of the flakes from stage b), to form granules. The subsequent stages are subsequently carried out typically on these granules.

Stage c) can comprise the mixing of the flakes obtained in stage b) with recycled or virgin polypropylene in a flakes: recycled (or virgin) PP ratio ranging from 1:99 to 99:1, preferably from 5:95 to 95:5, for example from 5:95 to 50:50.

The recycled or virgin polypropylene of stage c) can be in the form of flakes or of granules, preferably in the form of flakes.

Stage d) can be an extrusion, coextrusion or molding, for example injection molding, stage.

Extrusion (coextrusion) advantageously makes it possible to prepare recycled films, while molding advantageously makes it possible to prepare molded articles.

Preferably, stage d) is an injection molding stage.

The process advantageously makes possible a transformation of the multilayer system F1 into flakes or into granules which can be reused to manufacture a new article.

### Recycled Article

The description, embodiments and modes which are preferred disclosed above for the recycled article apply in the present process, without it being necessary to repeat them.

The present invention also relates to a recycled article liable to be obtained by the process for the preparation of a recycled article as defined above.

The present invention also relates to the use of the recycled article for the automotive field.

In the context of the invention, the term “of between x and y” or “ranging from x to y” is understood to mean an interval in which the limits x and y are included. For example, the range “of between 0% and 25%” includes in particular the values 0% and 25%.

The invention is now described in the following implementational examples which are given purely by way of illustration and should not be interpreted in order to limit the scope thereof.

### Examples

The following compounds were used in the context of the examples:

Kraton® D1111 sold by Kraton: composition, the overall content of styrenic units of which is 22%, and which consists of 82% of linear SIS triblock copolymer with an Mw of approximately 250 kDa and of 18% of SI diblock copolymer with an Mw of approximately 100 kDa.

Quintac® 3520 sold by Zeon Chemicals: composition consisting, respectively, of 22% and of 78% of linear SIS triblock (Mw of approximately 300 kDa) and of SI diblock (Mw of approximately 130 kDa), and the total content of styrenic units of which is 15%.

Quintac® 3433 N sold by Zeon Chemicals: composition consisting, respectively, of 44% and of 56% of linear SIS triblock (Mw of approximately 220 kDa) and of SI diblock (Mw of approximately 110 kDa), and the total content of styrenic units of which is 16.5%.

Escorez® 1310 LC available from Exxon Chemicals: a resin obtained by polymerization of a mixture of unsaturated aliphatic hydrocarbons having approximately 5 carbon atoms and which has a softening temperature of 94° C. and a weight-average molar mass Mw of approximately 1800 Da.

Regalite® R1125 available from Eastman: hydrogenated resin which has a softening temperature of 123° C. and a weight-average molar mass Mw of approximately 1200 Da.

### Example 1: Preparation of Hot-Melt Adhesive Compositions

The adhesive compositions (cf. table 1) are first prepared in the form of granules with a shape of approximately 4 mm in diameter, by mixing their ingredients by means of a twin-screw extruder, extrusion through a die and then cutting up the product using a granulating tool of underwater cutting type, then drying and cooling to ambient temperature (23° C.). Table 1 shows percentages by weight.

TABLE 1
adhesive compositions

| | Content as % weight/weight | | |
|---|---|---|---|
| Ingredient | Ex. A1 | Ex. A2 | Ex. A3 |
| Quintac ® 3433 N | 59.7 | — | — |
| Quintac ® 3520 | — | 59.7 | — |
| Kraton ® D1111 | — | — | 59.7 |
| Escorez ® 1310 LC | 39.8 | — | — |
| Regalite ® R1125 | — | 39.8 | 39.8 |
| Antioxidant | 0.5 | 0.5 | 0.5 |

### Example 2: Preparation of a Multilayer Film

A film is prepared consisting:
of a first polypropylene film (RD204CF from Borealis) with a thickness of 30 μm;
of an adhesive layer between the two films, resulting from the composition A1 of example 1 of 14 μm;
of a second polypropylene film (RD204CF from Borealis) with a thickness of 15 μm.

This three-layer film is manufactured by means of a continuously operating bubble blowing coextrusion pilot-scale device, in which three extruders are fed:
for one, with the composition A1 of example 1; and
for the other two, with polypropylene.

Several normal parameters were set, namely a degree of radial expansion of the bubble at 3.18, a drawing rate of 7 m/minute and an overall throughput of 11 kg/hour. The three-layer film thus obtained has a total thickness of 59 μm and a length of 50 m and is packaged in the form of a reel with a machine width of 250 mm.

The different substances were introduced into each extruder, in order to fill the screws and to form the polymer bubble at the outlet of the extrusion die. After purging for 30 minutes, the thicknesses and stability of the bubble controlled, 50 m of film were wound onto mandrels.

### Example 3: Process for the Preparation of Recycled Articles

### Grinding Stage 1

The multilayer complex of example 2, PP/adhesive/PP, is ground using an MDS 340/150 shredder, die of 8 mm, in order to obtain flakes. This grinding stage results in a mixture of flakes.

Stage 2: Mixing with a Reference

Subsequently, the flakes from stage 1 are mixed with recycled polypropylene granules (reference: PP sold by PreZero) in a ratio of 95:5 and 70:30 (reference: recycled multilayer film from stage 1). The mixture is introduced into a Berstorff ZE 25, 36 L/D, twin-screw extrusion line, melted at a temperature greater than their melting temperatures, and then extruded. On conclusion of this stage, granules are obtained.

The recycled polypropylene (reference) has an MFR of 8.95 g/10 min at 230° C. for a weight of 2.16 kg.

### Example 4: Mechanical and Thermal Properties of Molded Articles

### Breaking Strength/Elongation at Break

The breaking force is measured according to the standard ISO 527-1 (type 1A) on injection-molded samples by a tensile test carried out according to the protocol described below.

The principle of the measurement consists in drawing, in a tensile testing device, the movable jaw of which moves at a constant rate equal to 50 mm/minute, a standard test specimen consisting of the granules obtained in stage 2 (or reference granules) and in recording, at the moment when the test specimen breaks, the tensile stress applied (in MPa) and also the elongation of the test specimen (in %). The standard test specimen is dumbbell-shaped, as illustrated in the international standard ISO 527. The narrow part of the dumbbell used has a length of 80 mm, a width of 10 mm and a thickness of 4 mm.

### Impact Strength (Charpy)

The impact strength is measured according to the DIN EN ISO 179-2 1 eA method at 23° C. on ISO test specimens of type 1, with dimensions of 80×10× 4 mm (rate of 2.9 m/s).

The mechanical properties of the various articles prepared are described in the following table:

| | Recycled | | | | | | | | |
|---|---|---|---|---|---|---|---|---|---|
| | granules of | Recycled | Polypropylene | | Delta with | | | | |
| | example 3 - | polypropylene | granules | | respect to | | Delta with | | Delta with |
| | stage 2 | granules | (RD204CF | Tensile | the control | Elongation | respect to | Impact | respect to |
| | (% by | (reference) | from Borealis) | strength | 4.1 | at break | the control | strength | the control |
| Example | weight) | (% by weight) | (% by weight) | (MPa) | (relative) | (%) | 4.1 | (Charpy) | 4.1 |
| 4.1 (control) | 0% | 100% | — | 26.3 | n.a. | 7.79 | n.a. | 5.0 | n.a. |
| 4.2 | 5% | 95% | — | 26.1 | 0.8% | 8.11 | 4.1% | 5.7 | 14% |
| (invention) | | | | | | | | | |
| 4.3 | 30% | 70% | — | 25.1 | 4.6% | 9.35 | 20% | 6.2 | 24% |
| (invention) | | | | | | | | | |
| 4.4 | 0% | 70% | 30% | n.d. | n.d. | 8.45 | n.d. | 4.8 | n.d. |
| (comparative) | | | | | | | | | |

n.d.: not determined
n.a.: not applicable

The articles 4.2 and 4.3 advantageously exhibit breaking forces virtually similar to that obtained for the reference article (control 4.1) which does not comprise recycled granules of example 3. The articles 4.2 and 4.3 advantageously exhibit a higher elongation at break than that of the reference article (control 4.1). It is moreover higher for the article 4.3.

The articles 4.2 and 4.3 advantageously exhibit a higher impact strength than that of the reference article (control 4.1). It is moreover higher for the article 4.3.

The article 4.3 (invention) differs from the article 4.4 in that it comprises within it the hot-melt pressure-sensitive adhesive composition resulting from the recycled film of example 2. The results of the table demonstrate that, advantageously, the presence of the pressure-sensitive adhesive composition does not negatively impact the thermal and mechanical properties. On the contrary, the elongation at break and the impact strength are advantageously improved in comparison with an article 4.4 devoid of adhesive composition.

The MFR is described in the following table:

| | Recycled | Recycled | |
|---|---|---|---|
| | granules of | polypropylene | |
| | example 3 - | granules | MFR (g/10 min) |
| | stage 2 | (reference) | at 230° C. and |
| Example | (% by weight) | (% by weight) | 2.16 kg |
| 4.1 (control) | 0% | 100% | 8.95 |
| 4.2 (invention) | 5% | 95% | 9.08 |
| 4.3 (invention) | 30% | 70% | 8.29 |

The articles 4.2 and 4.3 advantageously exhibit an MFR close to the reference 4.1. This advantageously makes it possible to use injection molding conditions similar to the reference, without requiring additional adjustments.

1-15. (canceled)

16. A process for preparing a recycled article, comprising
providing a multilayer system F1 comprising:
a layer C1 comprising at least one polypropylene,
an adhesive layer Ad consisting of a hot-melt pressure-sensitive adhesive composition PC comprising:
a composition (a1) of styrenic block copolymers comprising at least one elastomer block; and
one or more tackifying resins (a2);
a layer C2 comprising at least one polypropylene,
said multilayer system F1 comprising at least 80% by weight of a polypropylene or of a mixture of polypropylenes, with respect to the total weight of said system, and
using the multilayer system F1 to prepare the recycled article.

17. The process as claimed in claim 16, characterized in that the composition (a1) of styrenic block copolymers comprising at least one elastomer block consists, on the basis of its total weight:
of from 10% to 90% by weight of at least one diblock copolymer chosen from the group consisting of SI, SBI, SIB, SB, SEB and SEP, and
of from 10% to 90% by weight of at least one triblock copolymer chosen from the group consisting of SIS, SIBS, SBS, SEBS and SEPS.

18. The process as claimed in claim 16, characterized in that the content of composition (a1) in the hot-melt pressure-sensitive adhesive composition PC ranges from 30% to 80% by weight, with respect to the total weight of said composition PC.

19. The process as claimed in claim 16, characterized in that the total content of styrenic units of said composition (a1) varies from 10% to 40% by weight, on the basis of the total weight of (a1).

20. The process as claimed in claim 16, characterized in that the content of diblock copolymer in the composition (a1) varies from 15% to 80%.

21. The process as claimed in claim 16, characterized in that the hot-melt pressure-sensitive adhesive composition PC comprises:
from 40% to 70% by weight of a composition (a1) of styrenic block copolymers comprising at least one elastomer block, said composition (a1) consisting, on the basis of its total weight:
of from 10% to 90% by weight of at least one diblock copolymer chosen from the group consisting of SI, SBI, SIB, SB, SEB and SEP, and
of from 10% to 90% by weight of at least one triblock copolymer chosen from the group consisting of SIS, SIBS, SBS, SEBS and SEPS;
the total content of styrenic units of said composition (a1) varying from 10% to 40% by weight, on the basis of the total weight of (a1); and
from 30% to 60% by weight of one or more tackifying resins (a2).

22. The process as claimed in claim 16, characterized in that the composition (a1) consists of an SIS triblock copolymer and of an SI diblock copolymer.

23. The process as claimed in claim 16, characterized in that the multilayer system F1 comprises at least 80% by weight, of polypropylene or of a mixture of polypropylenes, with respect to the total weight of said system.

24. The process as claimed in claim 16, characterized in that the recycled article is a single-layer film, a laminate, a (multilayer) complex or a molded article.

25. The process as claimed in claim 16, characterized in that the recycled article comprises at least 90%, of polypropylene or of a mixture of polypropylenes, with respect to the total weight of said recycled article.

26. The process as claimed in claim 16, said process comprising:
a) the provision of the multilayer system F1;
b) the conversion of the multilayer system F1 into flakes;
c) the optional mixing of the flakes obtained in stage b) with recycled or virgin polypropylene; and
d) the conversion of the flakes from stage b) or of the mixture from stage c) into a recycled article.

27. A recycled article obtained according to the process as defined in claim 26.

28. The recycled article according to claim 27, having improved impact strength.

29. The recycled article according to claim 27, having impact strength improved by at least 5%, in comparison with a control article consisting of 100% of polypropylene and devoid of the hot-melt pressure-sensitive adhesive composition PC.
